(19) United States
(12) Patent Application Publication
(10) Pub. No.: US 2015/0363140 A1
(43) Pub. Date: Dec. 17, 2015

(54) Composite To-Print Product

(71) Applicant: HEWLETT-PACKARD DEVELOPMENT COMPANY, L.P., Houston, TX (US)

(72) Inventors: Georgia Koutrika, PALO ALTO, CA (US); QIAN LIN, PALO ALTO, CA (US); JERRY J. LIU, PALO ALTO, CA (US)

(21) Appl. No.: 14/761,742

(22) PCT Filed: Jan. 24, 2013
(86) PCT No.: PCT/US2013/022866

§ 371 Date: Jul. 17, 2015

(51) Int. Cl. G06F 3/12

(52) U.S. Cl. CPC G06F 3/1204; G06F 3/1254; G06F 3/1273

(57) ABSTRACT

A system can include a print history analyzer to generate history data based on a document history that includes a list of documents selected to be printed. The history data can characterize a content and layout of documents selected for printing. The system can also include a user print profile builder to generate a user print profile based on the history data. The user print profile can characterize printing preferences of a user. The system can further include a recommendation engine to generate a composite to-print product for the user. The composite to-print product can be based on the user print profile.

### BACKGROUND

Digital printing (or simply printing) refers to methods of printing from a digital based image directly to a variety of media. In computing, a printer is a peripheral which produces a representation of an electronic file (e.g., a document) on physical media such as paper or transparency film. Some printers are local peripherals connected directly to a nearby personal computer. Some printers are network printers with built-in network interfaces that can serve any user on the network. Some local printers are designed to support both local and network connected users concurrently. Some printers can print documents stored on memory cards or from digital cameras and scanners.

### BRIEF DESCRIPTION OF THE DRAWINGS

FIG. 1 illustrates an example of a system for a generating a composite to-print product based on a user's print history.

FIG. 2 illustrates an example of a composite to-print product generator.

FIG. 3 illustrates a detailed example of a recommendation engine.

FIG. 4 illustrates a flowchart of an example method for generating a composite to-print product based on a user's print history.

FIG. 5 illustrates another example of a composite to-print product generator.

FIG. 6 illustrates a flowchart of another example method for generating a composite to-print product based on a user's print history.

### DETAILED DESCRIPTION

In many instances, there is a relatively strong correlation between user interest and a document selected for printing. Such a correlation is typically greater than, for example, user interest in a webpage that is merely viewed on an electronic display (e.g., a webpage that is not printed). A printing system can include a composite to-print product generator that can leverage the user interest by generating a composite to-print product based on a history of printing by a user.

The printing system can include a print history analyzer to analyze a user's printing and document history to generate history data for the user characterizing a content and layout of documents selected for printing. The history data can be employed by a user print profile builder to generate a user print profile that characterizes printing preferences of the user. The printing preferences can include, for example, content and page layout preferences, as well as temporal printing preferences (e.g., time of year). The printing preferences of the user can be employed by a recommendation engine to generate a composite to-print product for the user that can be based on the printing preferences. Thus, the composite to-print product can have a relatively high likelihood to be of interest to the user. The composite to-print product could be, for example, one or more of a news article, a coupon, an advertisement or the like. In some instances, the user can elect to print and use the composite to-print product.

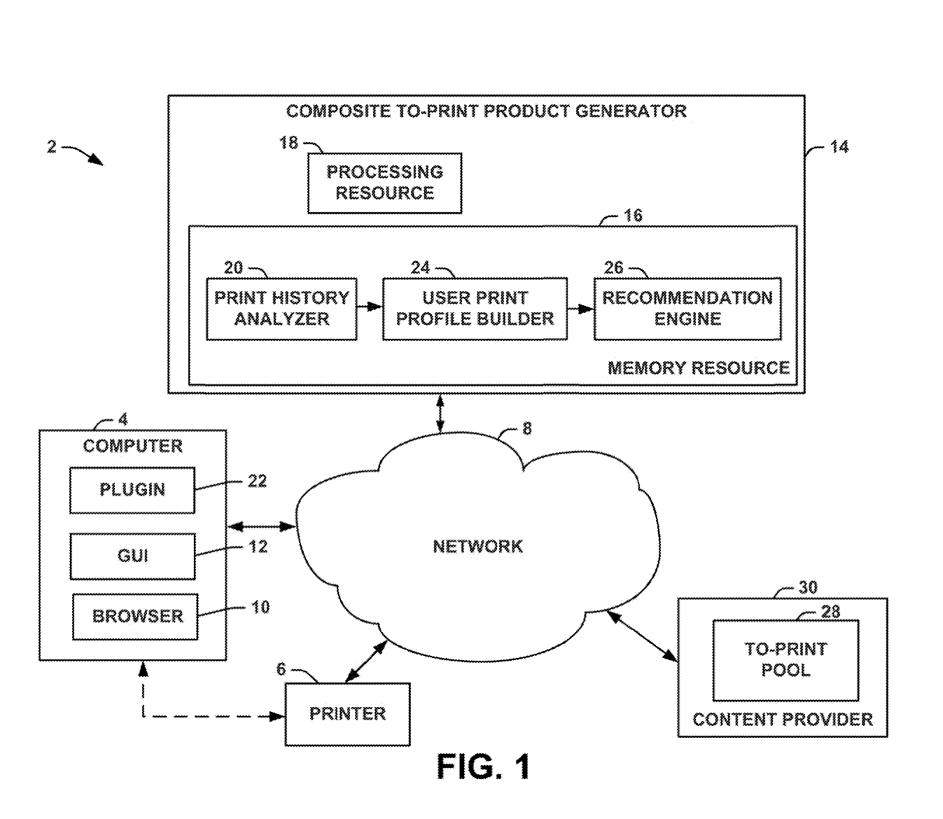

FIG. 1 illustrates an example of a system 2 for generating a composite to-print product for a user based on the user's print history. The composite to-print product can be implemented, for example as a personalized, printable product that can include material (e.g., an article, a coupon, an advertisement or the like) which the user is likely to be interested in given the user's past printing preferences in historical print jobs executed by the user. The composite to-print product can be formed, for example from multiple elements (e.g., content and/or presentation elements), such selected from a specific page, advertisement, an article, a page layout or the like. In some examples, the printable product can include a document in the portable document format (PDF). The system 2 can include, for example, a computer 4, such as a laptop, a desktop computer, a tablet computer, a smartphone or the like. The computer 4 can be employed to print material, such as files (e.g., documents) on a printer 6, such as a local printer or a network printer via a network 8. The network 8 could be implemented, for example as a public network (e.g., the Internet), a private network (e.g., a local area network) or a combination thereof. The printer 6 could be implemented, for example, as an inkjet printer, a laser printer or the like. In some examples, the computer 4 and the printer 6 could be integrated, such as in a smart printer. The user can interact with the computer 4 can interact via user input and user output.

In some examples, the computer 4 can include a browser 10 that can access webpages on the network 8. Moreover, the computer 4 can include a graphical user interface (GUI) 12 that can be employed to interact with (e.g., browse) the webpages on the network 8. In some examples, in response to user input, the GUI 12 can initiate a print job to print a given file on the printer 6. The given file could represent, for example, a webpage, a document, an email or the like. In some examples, the given file can be stored on the computer 4 (e.g., stored in non-volatile memory). In other examples, the given file can be stored on an external server (e.g., a webserver). In many instances, there is a relatively strong correlation between user interest and a file selected for printing. Such a correlation is typically greater than, for example, user interest in a webpage that is merely viewed on an electronic display (e.g., a webpage that is not printed). The system 2 can include a composite to-print product generator 14 that can leverage the user interest.

The composite to-print product generator 14 can be implemented, for example, on a computer, such as a server. Additionally or alternatively, the composite to-print product generator 14 can be integrated with the computer 4 and/or the printer 6. The composite to-print product generator 14 can include a memory resource 16 to store machine readable instructions. The memory resource 16 could be implemented, for example, as volatile memory (e.g., random access memory) non-volatile memory (e.g., a hard disk drive, a solid state drive, flash memory or the like). The composite to-print product generator 14 can also include a processing resource 18 to access the memory resource 16 and execute the machine readable instructions. The processing resource 18 could include, for example, a processor core.

The memory resource 16 can include a print history analyzer 20 that can analyze a print history of the user. In the present examples, the term “user” can represent a single person or multiple people that share a single computer access account (e.g., a single login). For instance, in some examples, multiple people can share the same account on the computer 4. In such a situation, the “user” would be representative of all such multiple people. Further, in the present examples multiple users represent multiple accounts (e.g., multiple logins) even if the same person employs each of the multiple accounts. In some examples, the print history analyzer 20 can access the browser 10 of the computer 4 and examine a document history (e.g., a browsing history) of the browser 10. To access the browser 10, in some examples, the computer 4 can include a plugin 22 (e.g., an applet) that can communicate with the browser 10 and the print history analyzer 20. The document history can include, for example, a list of webpages viewed by the user. The list of the webpages can include, for example, a source (e.g., a uniform resource locator (URL)) of the webpage. Additionally, the document history can include a list of webpages selected for printing by the user. In other examples, the plugin 22 can monitor printing activity of the user and provide corresponding print history data to the print history analyzer 20 in the memory resource 16 such as to identify webpages selected for printing by the user.

The print history analyzer 20 can generate history data for the user that characterizes each webpage in the document history and/or the print history data. To generate the history data, the print history analyzer 20 can employ a method or a combination of different methods, such as rules and/or machine learning techniques (e.g., a classifier, a neural network or the like) to generate content data for the history data to characterize content of each webpage in the document history that can summarize the content on each webpage. The content data can include, for example, a keyword and/or a phrase in a given webpage characterized in the history data for the user. The content data can include, for example, the source of the given webpage (e.g., a uniform resource location (URL)), a type of the given webpage (e.g., an article web page, instructions, a printable webpage or the like) a category of the given webpage (e.g., a news article, a food recipe, a coupon, an advertisement or the like) a topic (e.g., a chicken recipe, a news article about a certain election, an automotive advertisement or the like). Additionally, the content data can include data identifying whether the given webpage was selected for printing, and a time (e.g., a date) that such a selection for printing occurred.

The print history analyzer 20 can also employ a method or a combination of different methods, such as rules and/or machine learning techniques to generate layout data of the history data that characterizes a page layout of each webpage in the document history. The layout data for the given webpage can include, for example, an aesthetic element (e.g., a font used), a number of images on the given webpage, a percentage of the given webpage that includes text or the like. In this manner, the history data can characterize both the content (e.g., the content data) and the page layout (e.g., the layout data) of each webpage in the document history.

Additionally, the history data for the user can be incrementally updated by the print history analyzer 20 in response to a document being selected for printing. For instance, the print history analyzer 20 can detect that a print job on the printer 6 that includes a given file has been generated, thereby causing the printer 6 to print the given file. A print job is a file or set of files that has been submitted to be printed. In some examples, to detect the print job, the print history analyzer 20 can receive a print message from the plugin 22 installed on the computer 4 that characterizes the given file in the print job. In other examples, such as where the printer 6 is connected to the computer via a server (e.g., a printer server), the server can provide a respective print message that characterizes the given file in the print job. Such a characterization of the given file can include, for example, a source of the given file, which source could be implemented, for example, as a uniform resource locator (URL), in examples where the given file corresponds to a webpage. In some examples, the given file can be included with the print message. In other examples, the given file can be omitted from the print message. The print history analyzer 20 can analyze the given file to determine history data for the given file. The history data for the given file can be inserted to the history data of the document history. In this manner, the history data can be incrementally updated each time a document is selected to be printed. The history data can be provided to a user print profile builder 24 that can be stored in the memory resource 16.

The user print profile builder 24 can generate a user print profile based on the history data. The user print profile can include data that characterizes printing preferences of the user. The user print profile builder 24 can employ a method or a combination of different methods, such as rules and/or machine learning techniques to generate profile content data of the user print profile. The profile content data can represent an aggregate (e.g., summary) of the content data included in the history data. That is, the profile content data can include features, such as a list of websites that the user is likely to print from, the type of webpages the user is likely to select to print, topics of interest to the user or the like that can be derived from an aggregation by the user print profile builder 24 of the content data, wherein the aggregation is determined by the method (or combination of methods) employed to generate the user print profile to identify trends (which can include user preferences) in the content data. Additionally, the profile content data can specify a time associated with each feature (or some subset thereof) in the profile content data. Further, the profile content data can indicate that the user typically does not print webpages that includes certain content, which can be based on an examination of the history data, wherein the history data indicates that the user has browsed webpages that include particular types of content, while the user has printed relatively few (or no) such webpages. Further, the user print profile builder 24 can update the profile content data incrementally, such as in response to an update to the history data.

Additionally, the user print profile builder 24 can a employ method or a combination of different methods, such as rules and/or machine learning techniques to aggregate (e.g., summarize) the layout data of the history data to generate profile presentation data that characterizes a page layout (e.g., a presentation) of a printable page that the user is likely to find interesting. The profile presentation data can include data that describes aesthetic properties of webpages selected for printing by the user, tolerance to coupons and/or advertisements included in a printed webpage, a page layout or the like. Similar to the profile content data, the profile presentation data can be updated incrementally, such as in response to an update to the history data. In this manner, the user print profile can characterize printing preferences of the user that are based on an aggregate of webpages viewed and printed (or not printed) by the user. The user print profile can be provided to a recommendation engine 26 stored in the memory resource 16.

The recommendation engine 26 can select a subset (e.g., a proper subset) of elements from a to-print pool 28 based on the user print profile. The content elements could include, for example, a content element and/or a presentation element. The to-print pool 28 can be stored, for example, on a content provider 30 to generate the composite to-print product. In some examples, the content provider 30 can be a web server that stores the to-print pool 28 in a database. In other examples, the content provider 30 can be representative of multiple content providers, wherein each content provider includes a subset of the elements in the to-print pool 28. Additionally or alternatively, the content provider 30 could be implemented, for example, as a cloud service (e.g., cloud storage) or the like. In such a situation, the term “cloud” can indicate a network fabric that includes a virtualized pool of computers that can be hosted, for example, by a cloud host (e.g., a third party). The elements (e.g., content elements) in the to-print pool 28 can be, for example specific instances of an image, an advertisement, an article, a presentation element (e.g., a page layout) or the like. The presentation element (e.g., a page layout) can include, for example, a grid that implements a set of guidelines (e.g., parameters), that can be employed for, for aligning and repeating elements (e.g., text, images or the like) on a page. Additionally or alternatively, the page layout can include a template that can define positions for elements (e.g., text, images or the like) on a page.

The recommendation engine 26 can be programmed to define parameters for the generation of the composite to-print product. Such parameters can be employed by the recommendation engine 26 to control the elements in the to-print pool 28. For instance, the recommendation engine 26 can select content elements of the to-print pool 28 to that are relevant to a specific time (e.g., the holiday season, summer time, or the like). Additionally, the recommendation engine 26 can select content elements of the to-print pool 28 elements that are relevant to a specific location, such as a location of the user. Moreover, the recommendation engine 26 can select content elements of the to-print pool 28 that are relevant to properties of the printer 6. For instance, if the printer 6 is a black and white printer, the recommendation engine 26 could be set to remove content elements from the to-print pool 28 that are related to high resolution color images. The set of content elements that remain (e.g., have not been removed by the recommendation engine 26) in the to-print pool 28 for a given user can be referred to as a filtered to-print pool for the given user.

Additionally, the recommendation engine 26 can determine content elements in the filtered to-print pool for the given user that the user is likely to be interested in. The recommendation engine 26 can be configured to recommend specific instances of particular types of content elements for the user, which can be referred to as recommended elements of the to-print pool. In some examples, the recommendation engine 26 can assign a ranking corresponding to the likelihood that the user will be interested in a type of recommended content element (e.g., a specific coupon) based on the user's print profile. Thus, for each type of content element in the filtered to-print pool, the recommendation engine 26 can recommend and rank elements of a given type. The recommended elements and ranking of each of the recommended elements can be employed by the recommendation engine 26 to select a set of candidate elements to be included in a to-print product.

As a further example, the recommendation engine 26 can examine the recommended elements and associated rankings to determine a set of the recommended elements that can be packaged together into a (single) candidate product. To determine the set of recommended elements for a given candidate product, a composite content composer can weigh a number of factors (e.g., time, diversity, relatedness, profitability or the like) for the recommended elements. Additionally, in some examples, the recommendation engine 26 can generate a plurality of candidate products by weighing the factors (e.g., time, diversity, relatedness, profitability or the like) differently for each of the candidate products.

The recommendation engine 26 can be configured to generate a plurality of candidate to-print products that can include a page layout designed to have a visually appealing presentation for each of the plurality of candidate products. The page layout of the candidate to-print products can be based on the profile presentation data of the user print profile, and/or a presentation element (e.g., a grid and/or a template) in the to-print pool 28 or the like. Additionally, the recommendation engine 26 can rank each of the plurality of candidate to-print products to indicate a likelihood that a particular candidate to-print product will be of interest to the user. Moreover, in some examples, the recommendation engine 26 can determine that none of the plurality of candidate print products meets a certain predefined ranking threshold. In such a situation, the recommendation engine 26 can generate one or more additional candidate products that can be evaluated in the manner described.

The recommendation engine 26 can select the composite to-print product from the plurality of candidate products, such that the composite to-print product can be formed from multiple content elements in the to-print pool. The selection can be based on a time of year, the user print profile, the ranking of the plurality of candidate to-print products or the like. Moreover, in some examples, the recommendation engine 26 can determine that none of the plurality of candidate to-print products meets (or is a best fit for) a certain predefined ranking threshold. In such a situation, the recommendation engine 26 can provide one or more additional candidate to-print products that can be evaluated in the manner described. The composite to-print product can be provided to the computer 4 via the plugin 22. In some examples, different candidate to-print products can be provided to the computer 4 at regular intervals (e.g., once an hour, once a day or the like), which regular intervals can be set at the plugin 22 of the computer 4.

In some examples, the computer 4 can display the composite to-print product to the user via the GUI 12. The user can elect or decline to print the composite to-print product on the printer 6 in by employing user input via the GUI 12. Moreover, if the user elects to print the composite to-print product, a print message can be provided to the print history analyzer 20 indicating that the composite to-print product has been selected for printing. In turn, the history data and the user print profile can be updated in a manner described herein. Thus, the printing (or the declining of printing) of the composite to-print product can be captured (e.g., via the plugin 22) and provided to the print history analyzer as feedback to update the printing preferences of the user.

By utilization of the system 2, the user's experience can be enhanced since the composite to-print product is likely to be of interest to the user, based on the user's past printing history. Moreover, material included in the composite to-print product can be marketed, such that a new revenue stream can be generated.

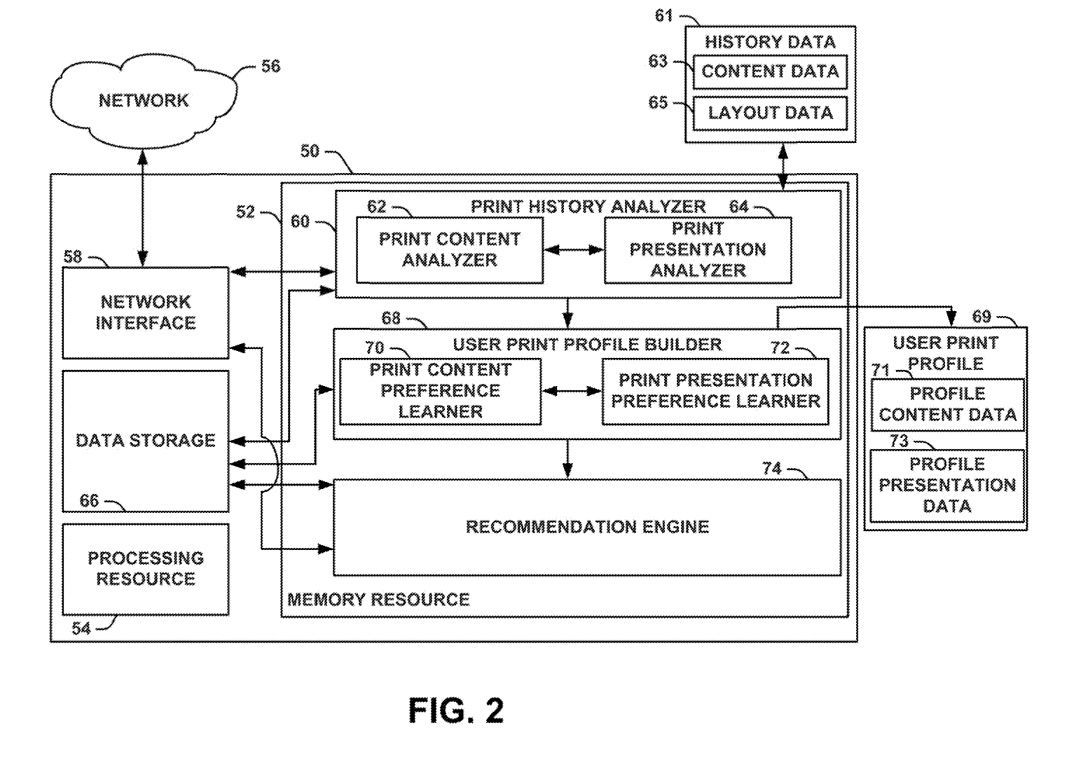

FIG. 2 illustrates an example of a composite to-print product generator 50 that can be utilized to implement the composite to-print product generator 14 illustrated in FIG. 1. The composite to-print product generator 50 can include a memory resource 52 for storing machine executable instructions. The memory resource 52 could be a non-transitory machine readable medium. For instance, the memory resource 52 could be implemented, for example, as random access memory, flash memory, a hard disk, a solid state drive or a combination thereof. The composite to-print product generator 50 can also include a processing resource 54 that can access the memory resource 52 and execute machine executable instructions. The processing resource 54 can be implemented, for example, as a processor core. The composite to-print product generator 50 can be coupled to a network 56 (e.g., the Internet and/or a local area network) via a network interface 58, which could be implemented as a network interface card.

The memory resource 52 can include a print history analyzer 60 that can analyze a print history of a user. In some examples, the print history analyzer 60 can access, via the network interface 58, a browser of a computer employed by the user and examine a document history of the browser (e.g., a browsing history). The document history can include, for example, a list of webpages viewed by the user. The list of the webpages can include, for example, a source (e.g., a URL) of the webpage. Additionally, the document history can include a list of webpages selected for printing by the user. The print history analyzer 60 can include a print content analyzer 62 and a print presentation analyzer 64 to generate history data 61.

The print content analyzer 62 can employ a method or a combination of different methods, such as rules and/or machine learning techniques (e.g., a classifier, a neural network or the like) to generate content data 63 for the history data 61 that characterizes content of each webpage in the document history that can summarize the content on each webpage. The content data can include, for example, a keyword and/or a phrase in a given webpage in the history data 61. For instance, the content data 63 can include, for example, the source of the given webpage, a type of the given webpage (e.g., an article web page, instructions, a boarding pass, a printable webpage or the like) a category of the given webpage (e.g., a news article, a food recipe, a coupon, an advertisement or the like) a topic (e.g., a chicken recipe, a news article about a certain election, an automotive advertisement or the like) that characterizes each webpage in the document history. Additionally, the content data 63 can include data identifying whether the given webpage was selected for printing, and a time (e.g., a date) that such a selection for printing occurred.

The print presentation analyzer 64 of the print history analyzer 60 can employ a method or a combination of different methods, such as rules and/or machine learning techniques to generate layout data 65 of the history data 61 that characterizes a layout of each webpage in the document history. The layout data 65 for the given webpage can include, for example, an aesthetic element (e.g., a font used), a number of images on the given webpage, a percentage of the given webpage that includes text or the like. In this manner, the history data 61 can characterize both the content (e.g., the content data 63) and the page layout (e.g., the layout data 65) of each webpage in the document history.

Additionally, the history data 61 can be incrementally updated in response to a document being selected or not selected for printing. For instance, the print history analyzer 60 can detect that a print job on a printer that includes a given file has been generated, thereby causing the printer to print the given file. In some examples, to detect the print job, the print history analyzer 60 can receive a print message from a plugin (e.g., an applet) installed on the computer via the network 56 that characterizes the given file in the print job. In other examples, such as examples where the composite to-print product generator 50 is integrated with a server (e.g., a printer server), the server can provide a similar print message that characterizes the given file in the print job. Such a characterization of the given file can include, for example, a source of the given file, which source could be implemented, for example, as a URL, in examples where the given file corresponds to a webpage. In some examples, the given file can be included with the print message. In other examples, the given file can be omitted from the print message. The print content analyzer 62 and the print presentation of the print history analyzer 60 can analyze the print message to determine history data 61 for the given file (e.g., content data 63 and layout data 65). The history data 61 for the given file can be inserted to the history data 61 previously generated (e.g., update the history data 61). In this manner, the history data 61 can be incrementally updated each time a document is selected to be printed.

The history data 61 can be stored in data storage 66. The data storage 66 could be implemented, for example, as volatile or non-volatile memory (e.g., a hard disk drive, a solid state drive, flash memory or the like). Moreover, in some examples, the data storage 66 can include a database that can store the history data 61. In some examples, the memory resource 52 and the data storage 66 can be integrated together. In other examples, the memory resource 52 and the data storage can be connected over the network 56 and implemented on separate computer systems. Additionally, the history data 61 can be provided to a user print profile builder 68 that can be included in the memory resource 52.

The user print profile builder 68 can generate a user print profile 69 based on the history data 61. The user print profile 69 can include data that characterizes printing preferences of the user. The user print profile builder 68 can include a print content preference learner 70 and a print presentation preference learner 72 to generate the user print profile 69. The print content preference learner 70 can employ a method or a combination of different methods, such as rules and/or machine learning techniques to generate profile content data 71 of the user print profile 69 based on the content data 63 of the history data 61. The profile content data 71 can represent an aggregate of the content data 63 included in the history data 61. For instance, the profile content data 71 can include a list of websites that the user is likely to print from, the type of webpages the user is likely to select to print, topics of interest to the user or the like. Additionally, the profile content data 71 can specify a time associated with each feature of the profile content data 71. As an example, the profile content data 71 can include data that indicates that the user is interested in food recipes during the month of December (e.g., the holiday season), while the user is interested in exercise equipment in the month of January (e.g., New Year's resolution season).

Further, the print content preference learner 70 can derive information about the user based on the content data 63 of the history data 61. For instance, if the history data 61 indicates that a boarding pass for San Diego has been printed, the print content preference learner 70 can derive that the user has an upcoming trip on a specific date (indicated in the boarding pass) to San Diego.

Additionally, the profile content data 71 generated by the print content preference learner can indicate that the user typically does not print webpages that include certain content, which can be based on an examination by the print content preference learner 70 of the history data 61, wherein the history data 61 indicates that the user has browsed webpages that include particular types of content, while the user has printed relatively few (or no) such webpages. In one example, to generate the profile content data 71, the print content preference learner 70 of the user print profile builder 68 can parse the elements (e.g., keywords and/or phrases) in the content data 63 of the history data 61 and assign a score based on a number of occurrences of a given element as well as identifying a temporal relationship to a frequency of occurrences of the given element. The profile content data 71 can be updated incrementally, such as in response to an update to the history data 61.

The print presentation preference learner 72 can employ a method or a combination of different methods, such as rules and/or machine learning techniques to aggregate the layout data 65 of the history data 61 to generate profile presentation data 73 that characterizes a page layout (e.g., a presentation) of a printable page that the user is likely to find interesting. The profile presentation data 73 can include data that describes aesthetic properties of webpages selected for printing by the user, tolerance to coupons and/or advertisements included in a printed webpage, a page layout or the like.

In some examples, the print presentation preference learner 72 and the print content preference learner 70 can operate in concert, such that the profile presentation data 73 can indicate that the user has a bias toward (or against) a given page layout for a given type of webpage (e.g., a news article), and another bias toward (or against) another page layout for another type of webpage (e.g., a coupon). For instance, the profile presentation data 73 can include data that indicates that the user has a preference for printing a crowded webpage when the webpage is related to a technical article (e.g., an automotive performance chart), while concurrently, the user has a preference for printing a non-crowded webpage when the webpages are related to a coupon. Similar to the profile content data 71, the profile presentation data 73 can be updated incrementally, such as in response to an update to the history data 61. In this manner, the user print profile 69 can characterize printing preferences of the user that are based on aggregate of webpages viewed and printed (or not printed) by the user. The user print profile 69 can be provided to a recommendation engine 74 stored in the memory resource 52. Additionally, the user print profile 69 can be stored in the data storage 66.

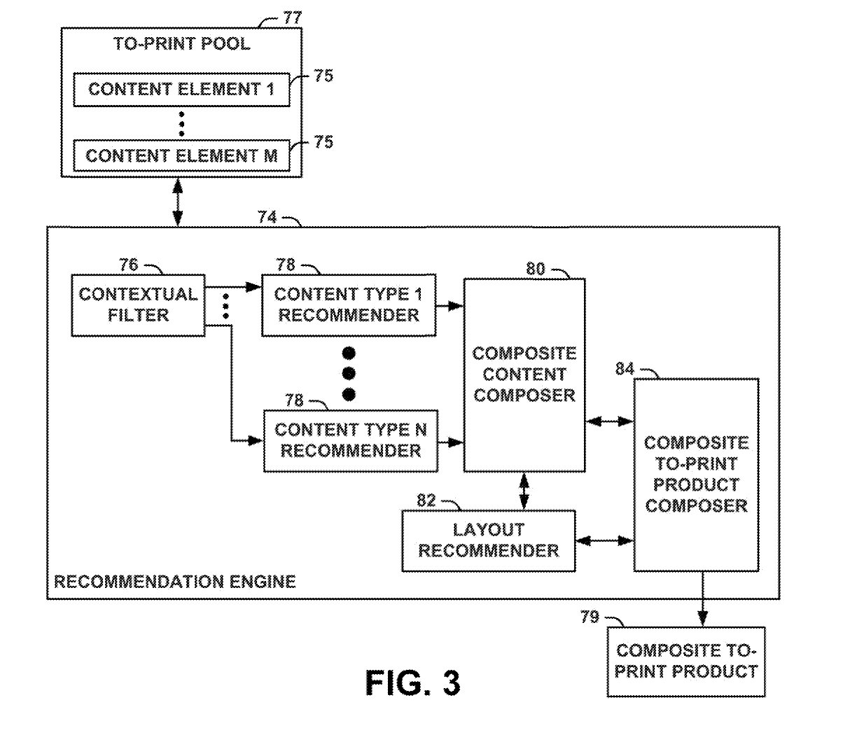

FIG. 3 illustrates a detailed diagram of the recommendation engine 74 illustrated in FIG. 2. For purposes of simplification of explanation, FIGS. 2 and 3 employ the same reference numbers to denote the same structure.

The recommendation engine 74 can select a subset of M number of content elements 75 from a to-print pool 77 that can be accessed via the network interface 58 to generate a composite to-print product 79, where M is an integer greater than or equal to two. The M number of content elements 75 in the to-print pool 77 can be, for example specific instances of an image, an advertisement, a presentation element (e.g., a page layout) or the like. In such a situation, the presentation element could be, for example, a template, a grid or the like.

The recommendation engine 74 can include a contextual filter 76 that can be programmed to define parameters for the generation of the composite to-print product 79. The contextual filter 76 can be employed to control the M number of content elements 75 in the to-print pool 77. For instance, the contextual filter 76 can select content elements 75 of the to-print pool 77 that are relevant to a specific time (e.g., the holiday season, summer time, or the like). Additionally, the contextual filter 76 can control the M number of content elements 75 based on properties included in the user print profile 69. For instance, the contextual filter 76 can select content elements 75 of the to-print pool 77 that are relevant to a specific location, such as a location of the user. As one example, if the user is located in West Linn, Oregon, the contextual filter 76 could be set to remove elements in the to-print pool 77 that are related to advertisements from retail locations that are more than 50 miles from West Linn, Oregon. Additionally or alternatively, in the example where the user has printed a boarding pass to San Diego at a given date, during a time near the given date (e.g., up to two weeks before the given date) the contextual filter 76 can select content elements 75 of the to-print pool 77 related to San Diego, such as a coupon for a zoo in San Diego. Moreover, the contextual filter 76 can select content elements 75 of the to-print pool 77 that are relevant to properties of the printer. For instance, if the printer is a black and white printer, the contextual filter 76 could be set to remove elements from the to-print pool 77 that are related to high resolution color photographs. The set of content elements 75 that remain (e.g., have not been removed by the contextual filter 76) in the to-print pool 77 can be referred to as a filtered to-print pool. The filtered to-print pool can be provided to N number of content type recommenders 78 of the recommendation engine 74, where N is an integer greater than or equal to one.

The N number of content type recommenders 78 of the recommendation engine 74 can employ the profile content data 71 of the user print profile 69 to determine content elements 75 in the filtered to-print pool that the user is likely to be interested in. Each of the N number of content type recommenders 78 can be configured to recommend a particular type of content element 75 for the user. For instance, a first content type recommender 78 of the plurality of recommenders 78 could be a coupon recommender that can recommend a coupon for the user. In some examples, the coupon recommender 78 can assign a ranking corresponding to the likelihood that the user will be interested in a recommended coupon. In some examples, to recommend and rank elements in the filtered to-print pool, the first recommender 78 can employ a user print profile 69 of multiple users that can be stored in the data storage 66. Moreover, in a similar manner, a second content type recommender 78 of the N number of content type recommenders 78 could be an advertisement recommender, while a third content type recommender 78 could be an article recommender. Thus, for each type of content element 75 in the to-print pool 77, a corresponding content type recommender 78 can be employed to recommend and rank elements of a given type. The recommended element and ranking of each of the recommended element can be provided to a composite content composer 80 of the recommendation engine 74.

The composite content composer 80 of the recommendation engine 74 can examine the recommended element and ranking provided from each of the N number of content type recommenders 78 to determine a set of the recommended elements that can be packaged together into a (single) candidate product. Additionally, in some examples, the composite content composer 80 can generate a plurality of candidate products by weighing the factors differently for each of the plurality candidate products. To determine the set of recommended elements for a given candidate product, the composite content composer 80 can weigh relatedness (e.g., one of the factors) of content elements 75. For instance, the composite composer can ensure that the set of recommended elements can have a certain degree of relatedness (e.g., each related to automobile) and that the set of recommended elements in the given candidate product are likely to be of interest to the user. Another such factor could be diversity. In such an example, the composite content composer 80 can ensure that the type of elements in the set of recommended elements in the given candidate product achieves a certain degree of diversity. Yet another such factor could be profitability. In some examples, a provider of elements in the to-print pool 77 can provide a fee (or a potential fee) to a business associated with the composite to-print product generator 50 for each time (or some subset thereof) that a certain content element 75 in the to-print pool 77 is included in the set of recommended elements of the given candidate product. In such examples, the composite content composer 80 can ensure that a certain degree of profitability is attained in the set of recommended elements in the given candidate product. The plurality of candidate products can be provided to a layout recommender 82 and a composite to-print product composer 84 of the recommendation engine 74.

The layout recommender 82 of the recommendation engine 74 can be configured to generate a plurality of candidate to-print products that can include a page layout designed to be visually appealing page layout for each of the plurality of candidate products. The page layout of the candidate to-print products can be based on the profile presentation data 73 of the user print profile 69, page layout and/or presentation elements in the to-print pool 77 or the like. Moreover, the page layout recommender 82 can rank each of the plurality of candidate to-print products to indicate a likelihood that a particular candidate to-print product will be of interest to the user. Moreover, in some examples, the page layout recommender 82 can determine that none of the plurality of candidate print products meets a certain predefined ranking threshold. In such a situation, the page layout recommender 82 can query the composite content composer 80 for one or more additional candidate products that can be evaluated in the manner described. The plurality of candidate to-print products can be provided to a composite to-print product composer 84 of the recommendation engine 74.

The composite to-print product composer 84 can select the composite to-print product 79 from the plurality of candidate products. The selection can be based on a time of year, the user print profile 69, the ranking of the plurality of candidate to-print products or the like. Moreover, in some examples, the composite to-print product composer 84 can determine that none of the plurality of candidate to-print products meets (or is a best fit for) a predefined ranking threshold. In such a situation, the composite to-print product composer 84 can query the layout recommender 82 for one or more additional candidate to-print products and/or the composite content composer 80 for one or more additional candidate to-print products that can be evaluated in the manner described.

Referring back to FIG. 2, the composite to-print product 79 can be stored in the data storage 66. Additionally or alternatively, the composite to-print product 79 can be stored in a server (e.g., a cloud server). Moreover, the composite to-print product 79 can be provided to the computer (e.g., computer 4 of FIG. 1), such as via the plugin. Additionally or alternatively, the composite to-print product 79 can be sent directly to a printer, such as a network printer or a local printer, such the printer 6 illustrated in FIG. 1. In some examples, different candidate to-print products can be provided to the computer and/or the printer via the network interface 58 at regular intervals (e.g., once an hour, once a day or the like), which regular intervals can be set at the plugin of the computer and/or the printer.

In some examples, the computer can display the composite to-print product 79 to the user via a GUI. The user can elect or decline to print the composite to-print product 79 on the printer. Moreover, if the user elects to print the composite to-print product 79, a print message can be provided via the network interface 58 to the print history analyzer 60 indicating that the composite to-print product 79 has been selected for printing. In turn, the history data 61 and the user print profile 69 can be updated in a manner described herein. Thus, the printing (or the declining) of printing the composite to-print product 79 can provide feedback as to the printing preferences of the user.

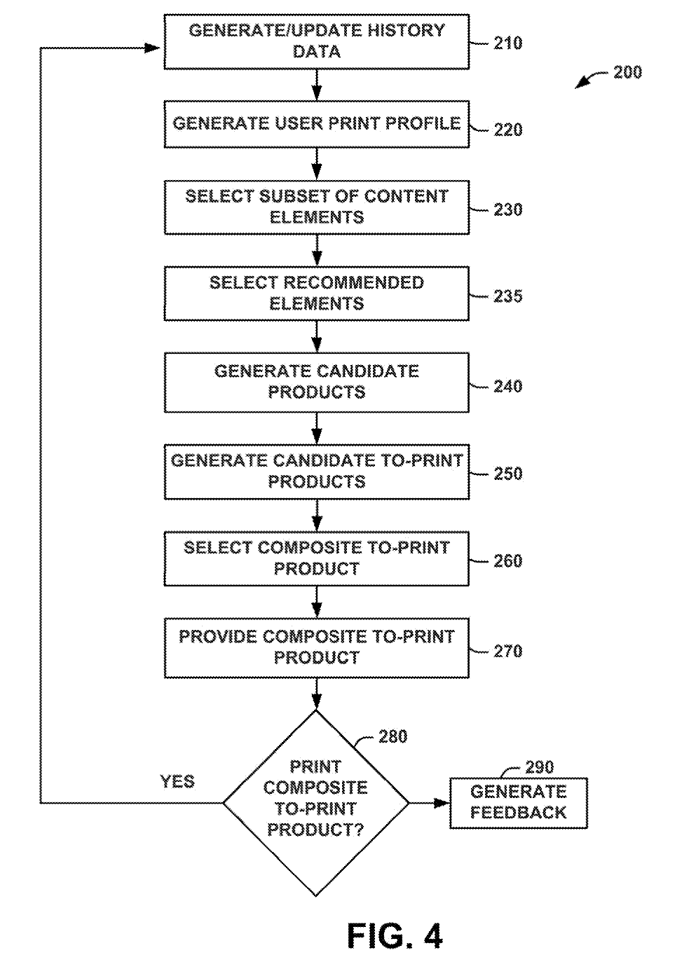

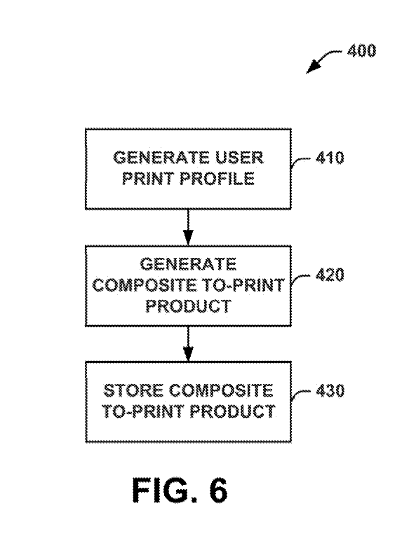

In view of the foregoing structural and functional features described above, example methods will be better appreciated with reference to FIGS. 4 and 6. While, for purposes of simplicity of explanation, the example methods of FIGS. 4 and 6 are shown and described as executing serially, it is to be understood and appreciated that the present examples are not limited by the illustrated order, as some actions could in other examples occur in different orders and/or concurrently from that shown and described herein. Moreover, it is not necessary that all described actions be performed to implement a method. The example methods of FIGS. 4 and 6 can be implemented as instructions stored in a non-transitory machine-readable medium. The instructions can be accessed by a processing resource and executed to perform the methods disclosed herein.

FIG. 4 illustrates a flow chart of an example method 200 for generating a composite to-print product for a user based on the user's print history. The method 200 could be executed for example, by a composite to-print product generator (e.g., the composite to-print product generator 14 illustrated in FIG. 1 and/or the composite to-print product generator 50 illustrated in FIG. 2). At 210 print history data can be generated and/or updated by a print history analyzer (e.g., the print history analyzer 20 illustrated in FIG. 1). The print history data can include content data that characterizes content of webpages and other documents that have been viewed and printed by the user. The print history data can also include layout data that characterizes a page layout of webpages and other documents that have been viewed and printed by the user. The print history can be based, for example, on a document history of a browser (e.g., the browser 10 illustrated in FIG. 1). Moreover, the history data can be generated and/or updated incrementally in response to a print message that indicates that a given file has been printed.

At 220, a user print profile can be generated and/or updated (e.g., by the user print profile builder 24 illustrated in FIG. 1). The user print profile can include data that characterizes the user's printing preferences. The user print profile can include profile content data that characterize content of webpages that are likely to interest the user. In some examples, the profile content data can represent an aggregate of the content data included in the history data for each respective user. The profile content data can include, for example a list of websites the user is likely to print from, topics of interest to the user, a type of webpages the user is likely to select to print or the like. Additionally, the user print profile can include profile presentation data that characterizes a page layout of a printable page that the user is likely to find interesting. The profile presentation data can represent an aggregate of the content data included with the history data for each respective user. The profile presentation data can also indicate the user's tolerance to coupons and/or advertisements included in a printed webpage.

At 230, a recommendation engine (e.g., the recommendation engine 26 illustrated in FIG. 1 and/or 74 of FIG. 3) can select a subset of content elements from a to-print pool that can be employed to generate a filtered to-print pool. The selection of the subset of the elements can be based, for example, on the time of year, the user print profile, business relationships or the like. At 235, the recommendation engine can select a set of recommended elements from the filtered to-print pool based on the user print profile. At 240, a plurality of candidate products can be generated by the recommendation engine. To generate each of the plurality of candidate products, the recommendation engine can parse the set of recommended elements and select a subset of the recommended elements based on a number of factors (e.g., relatedness of each element in the recommended elements, diversity, profitability or the like). At 250, a plurality of candidate to-print products can be generated by the recommendation engine from the plurality of candidate products. Generation of the candidate to-print products can be based, for example, on the layout data of the user print profile and/or a page layout element included in the to-print pool. At 260, the composite to-print product can be selected by the recommendation engine from a ranking of each of the candidate to-print products. The composite to-print product can be in a printable format (e.g., PDF). At 270, the composite to-print product can be provided from the recommendation engine to a computer (e.g., the computer 4 illustrated in FIG. 1). The computer can provide (e.g., display) the composite to-print product to the user.

At 280, a determination can be made as to whether the user has elected to print the composite to-print product on a printer (e.g., the printer 6 illustrated in FIG. 1), such as in response to a user input. The determination can be made, for example by the print history analyzer in response to receipt (or lack of receipt) of a print message that indicates that the composite to-print product has been selected for printing. If the determination is positive (e.g., YES), the method 200 can return to 210 where the history data can be updated based on the election to print the composite to-print product. If the determination is negative (e.g., NO), the method 200 can proceed to 290, where feedback for the print history analyzer can be generated, which feedback can indicate that the composite print product was not selected for printing. Accordingly, the determination at 280 can be employed as feedback as to the user's printing preferences.

By utilization of the method 200, a user's experience can be enhanced since the composite to-print product is likely to be of interest to the user, based on the user's past printing history. Moreover, material included in the composite to-print product can be marketed, such that a new revenue stream can be generated.

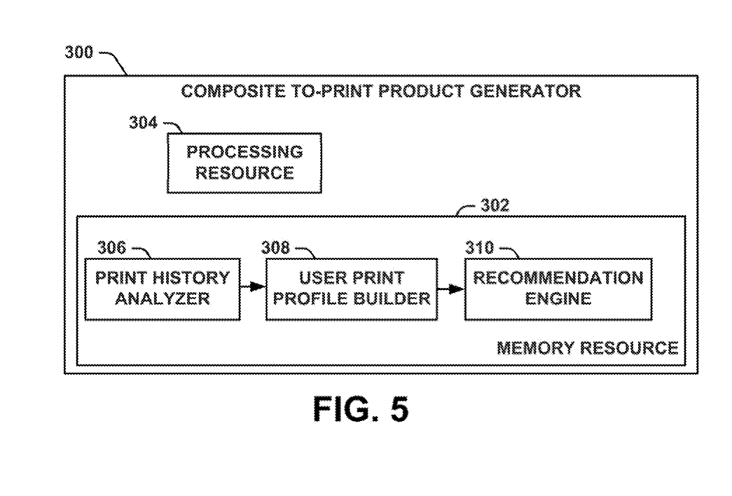

FIG. 5 illustrates another example of composite to-print product generator 300 that can be employed to generate a composite to-print product based on a user's print history. The composite to-print product generator 300 could be employed for example to implement the composite to-print product generator 14 illustrated in FIG. 1. The composite to-print product generator 300 can include a memory resource 302 (e.g., volatile or non-volatile memory) that can be employed to store machine readable instructions. The memory resource 302 could be a non-transitory machine readable medium. The composite to-print product generator 300 can also include a processing resource 304 (e.g., a processor core) that can access the memory resource 302 and execute the machine readable instructions. The memory resource 302 can include a print history analyzer 360 to generate history data for the user based on a document history that includes a list of documents selected to be printed. The history data can characterize a content and page layout of documents selected for printing. The memory resource 302 can also include a user print profile builder 308 to generate a user print profile based on the history data. The user print profile can characterize printing preferences of the user. The memory resource 302 can further include a recommendation engine 310 to generate the composite to-print product for the user. The composite to-print product can be based on the user print profile.

FIG. 6 illustrates another flowchart of an example method 400 for generating a composite to-print product based on a user's print history. The method 400 could be implemented, for example by the composite to-print product generator 14 illustrated in FIG. 1. At 410 a user print profile can be generated (e.g., by the user print profile builder 24 illustrated in FIG. 1) to characterize printing preferences of the user based on history data corresponding to a printing history of documents employed by the user. At 420, a composite to-print product for the user can be generated (e.g., by the recommendation engine 26 illustrated in FIG. 1). The composite to-print product can be based on the user print profile. At 430 the composite to-print product can be stored (e.g., by the recommendation engine) in a memory resource (e.g., the data storage 66 illustrated in FIG. 2).

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A non-transitory computer readable medium having machine executable instructions comprising:
a print history analyzer to generate history data for a user based on a document history that includes a list of documents selected to be printed, wherein the history data characterizes a content and a page layout of documents selected for printing;
a user print profile builder to generate a user print profile based on the history data, wherein the user print profile characterizes printing preferences of the user; and
a recommendation engine to generate a composite to-print product for the user, wherein the composite to-print product is based on the user print profile.

2. The non-transitory computer readable medium of claim 1, wherein the print history analyzer further comprises a print content analyzer to generate content data of the history data, wherein the content data includes a keyword of each document identified in the document history.

3. The non-transitory computer readable medium of claim 2, wherein the user print profile builder further comprises a print content preference learner to generate profile content data of the user print profile based on an aggregate of the content data of the history data, the profile content data to characterize content that is likely to be selected for printing by the user.

4. The non-transitory computer readable medium of claim 1, wherein the print history analyzer further comprises a print presentation analyzer to generate layout data of the history data that characterizes a page layout of each document included in the document history.

5. The non-transitory computer readable medium of claim 4, wherein the user print profile builder further comprises a print presentation preference learner to generate profile presentation data of the user print profile based on an aggregate of the layout data of the history data, the profile presentation data characterizing a page layout that is likely to be selected for printing.

6. The non-transitory computer readable medium of claim 1, wherein the recommendation engine further comprises a contextual filter to select a proper subset of content elements in a to-print pool of content elements, wherein the proper subset of content elements is selected based on the user print profile.

7. The non-transitory computer readable medium of claim 6, wherein the contextual filter is further to select the proper subset of content elements based on temporal printing preferences included in the user print profile.

8. The non-transitory computer readable medium of claim 6, wherein the recommendation engine further comprises a plurality of content type recommenders to generate a set of recommended elements, wherein a given content type recommender of the plurality of content type recommenders is to recommend a given content element of a respective content type selected from the proper subset of content elements.

9. The non-transitory computer readable medium of claim 8, wherein the recommendation engine further comprises:
a composite content composer to generate a plurality of candidate products that each include a proper subset of the set of recommended elements; and
a layout recommender to generate a page layout for each of the plurality of candidate products based on the user print profile to generate a plurality of candidate to-print products.

10. The non-transitory computer readable medium of claim 9, further comprising a composite to-print product composer to select the composite to-print product from the plurality of candidate to-print products based on the user print profile and a time parameter.

11. The non-transitory computer readable medium of claim 10, wherein the composite to-print product is generated in a printable format and the composite to-print product includes at least two of a coupon, an advertisement and an article.

12. The non-transitory computer readable medium of claim 9, wherein the print history analyzer is further to:
receive a print message indicating whether or not the composite to-print product has been selected to be printed; and
update the history data based on the print message.

13. A method comprising:
generating a user print profile to characterize printing preferences of a user based on history data corresponding to a printing history of documents employed by the user;
generating a composite to-print product for the user based on the user print profile; and
storing the composite to-print product in a memory resource.

14. The method of claim 13, further comprising updating the user print profile based on an incremental update to the history data.

15. A system comprising:
a memory resource to store machine readable instructions; and
a processing resource to execute the machine readable instructions, the machine readable instructions comprising:
a print history analyzer to generate history data for a user based on a document history that includes a list of documents selected to be printed;
a user print profile builder to generate a user print profile based on the history data, wherein the user print profile characterizes printing preferences of the user, the user print profile builder comprising:
a print content preference learner to generate profile content data of the user print profile based on an aggregate of content data of the history data, the profile content data characterizing content that is likely to be selected for printing; and
a print presentation preference learner to generate profile presentation data of the user print profile based on an aggregate of layout data of the history data, the profile presentation data characterizing a page layout of a printable page that is likely to be selected for printing; and
a recommendation engine to generate a composite to-print product for the user, wherein the composite to-print product is based on the user print profile.
